(19) United States
(12) Patent Application Publication
(10) Pub. No.: US 2026/0308076 A1
(43) Pub. Date: Oct. 8, 2026

(54) MINERAL PHOSPHATE ASH BASED FERTILIZER CONTAINING MAGNESIUM, PRODUCED FROM SEWAGE SLUDGE ASH, AND PROCESS FOR THE PRODUCTION THEREOF

(71) Applicant: ICL EUROPE COOPERATIEF U.A., Amsterdam (NL)

(72) Inventors: Lucas JOHANNES WILLIAM VAN DER SAAG, Amsterdam (NL); Khalil ABU-RABEAH, Beer Sheva (IL); Amir GERBER, Sheizaf (IL); Johan FRED VAN THIEL, Hoorn (NL); Anthony ZANELLI, Amsterdam (2H)

(21) Appl. No.: 19/097,905

(22) Filed: Apr. 2, 2025

(51) Int. Cl. C05B 13/00; C05B 17/00; C05B 19/00; C05C 3/00; C05D 1/00; C05D 3/00; C05D 5/00

(52) U.S. Cl. CPC C05B 13/00; C05B 17/00; C05B 19/00; C05C 3/005; C05D 1/005; C05D 3/00; C05D 5/00

(57) ABSTRACT

A mineral phosphate ash fertilizer produced from sewage sludge ash, having a NAC solubility of at least 90% of the total amount of P₂O₅, a water solubility of 15-80% of the total amount of P₂O₅, Magnesium in a concentration of 1-10%, Ammonium sulfate, and wherein the ratio between MgO and ammonium sulfate is between 1:2 to 1:4.

### FIELD OF THE INVENTION

The present invention relates to the field of fertilizers, specifically to production of fertilizers from a mineral phosphate ash source.

### BACKGROUND OF THE INVENTION

To grow properly, plants need nutrients (nitrogen, potassium, calcium, zinc, magnesium, iron, manganese, etc.) which normally can be found in the soil. Sometimes fertilizers are needed to achieve a desired plant growth as these can enhance the growth of plants.

This growth of plants is met in two ways, the traditional one being additives that provide nutrients. The second mode by which some fertilizers act is to enhance the effectiveness of the soil by modifying its water retention and aeration. Fertilizers typically provide, in varying proportions, three main macronutrients:
Nitrogen (N): leaf growth;
Phosphorus (P): Development of roots, flowers, seeds, fruit;
Potassium (K): Strong stem growth, movement of water in plants, promotion of flowering and fruiting;
three secondary macronutrients: calcium (Ca), magnesium (Mg), and sulphur (S); micronutrients: copper (Cu), iron (Fe), manganese (Mn), molybdenum (Mo), zinc (Zn), boron (B), and of occasional significance there are silicon (Si), cobalt (Co), and vanadium (V) plus rare mineral catalysts.

The most reliable and effective way to make the availability of nutrients coincide with plant requirements is by controlling their release into the soil solution, using slow release or controlled release fertilizers.

Both slow release fertilizers (SRF) and controlled release fertilizers (CRF) supply nutrients gradually. Yet, slow release fertilizers and controlled release fertilizers differ in many ways: The technology they use, the release mechanism, longevity, release controlling factors and more.

Phosphorus (P) is vital for healthy plant growth. When phosphorus is deficient, plant cells cannot function properly. Key processes such as photosynthesis and the transfer and storage of energy in plants suffer.

Without adequate phosphorus, plants show signs of weak health and poor growth. Crops need a good supply of phosphorus at every stage of the growing cycle. Phosphate fertilizers are essential to plant growth. Triple Super Phosphate (TSP fertilizer) and Single Super Phosphate (SSP fertilizer) enable good germination, optimum root development, and robust stalk and stem growth.

Healthy plants experience superior blooming and improved fruiting or grain formation. Correctly nourished plants are also more attractive to consumers, generally providing a greater nutrient density and tasting better. They also look more healthy and attractive on supermarket shelves.

### SUMMARY OF THE INVENTION

According to some demonstrative embodiments, there is provided herein a mineral phosphate ash fertilizer comprising a NAC solubility of at least 90% of total amount of P₂O₅ and a water solubility of 15-80% of the total amount of P₂O₅.

According to some embodiments, the water solubility of the total amount of P₂O₅ may be 15-55%.

According to some embodiments, the NAC solubility of the total amount of P₂O₅ may be at least 95%.

According to some embodiments, the fertilizer may have an abrasion of 0.05% or less, preferably, 0.02% or less.

According to some embodiments, the fertilizer may further include CaSO4.

According to some embodiments, the fertilizer may be produced from one or more P sources, including sewage sludge ash, bone meal ash or precipitated calcium phosphate (PCP).

According to some embodiments, the one or more P sources may preferably be sewage sludge ash (SSA).

According to some embodiments, the fertilizer may further comprise Iron Phosphate or Aluminum Phosphate in a concentration of at least 5% w/w.

According to some embodiments, the fertilizer may further comprise Ca(H2PO4)2H2O.

According to some embodiments, the fertilizer granule of the present invention may have a water uptake of at least 5% and a strength of at least 25 Newtons, after being placed in a climate chamber.

According to some embodiments, there is provided herein a process for the production of a mineral phosphate ash fertilizer comprising P2O5, said process comprising: mixing a mineral phosphate ash with sulfuric acid, phosphoric acid, a gas or a combination thereof, to provide an intermediate product; maintaining the intermediate product in a reactor or a belt between 2 minutes to 2 hours, to provide a cured intermediate product; and mixing said cured intermediate product with water or steam in a granulator.

According to some embodiments, the step of mixing the mineral phosphate ash with sulfuric acid, phosphoric acid or a combination thereof may be performed using bubbling, e.g., using gas.

According to some embodiments, mixing the cured intermediate product with water or steam in a granulator may further comprise adding a fertilizing compound.

According to some embodiments, the fertilizing compound may be selected from the group including Anhydrite, Potash, Polyhalite, Ammonium Sulphate, Urea, Gypsum, Kieserite, Epsomite. Glauberite, Blodite, Magnesia, Langbeinite, Kainite, Schonite or any other suitable fertilizer.

According to some embodiments, the fertilizing compound may preferably be Polyhalite, Kieserite, Urea or Potash.

According to some embodiments, the fertilizing compound may preferably be red Potash.

According to some embodiments, additional micronutrients may be added to the mixture, e.g., in order to enhance the nutrient value of the final fertilizer. According to some embodiments, the micronutrients may include: Nitrogen (N), Phosphorus (P), Potassium (K), calcium (Ca), magnesium (Mg), and Sulphur (S), copper (Cu), iron (Fe), manganese (Mn), molybdenum (Mo), zinc (Zn), boron (B), silicon (Si), cobalt (Co), vanadium (V) and rare mineral catalysts.

In some embodiments, there is provided a mineral phosphate ash fertilizer produced from sewage sludge ash (SSA), ammonium sulfate, and magnesium oxide (MgO).

In some embodiments, the fertilizer comprises:
A NAC solubility of at least 90% of the total amount of P₂O₅;
A water solubility of 15-80% of the total amount of P₂O₅;
Magnesium in a concentration between 1-1⁰%;
Ammonium sulfate, wherein the ratio between MgO and ammonium sulfate is between 1:2 to 1:4, preferably 1:2.9 (or 15:44).

In some embodiments, the process for producing the mineral phosphate ash fertilizer comprises:
Acidulating sewage sludge ash (SSA) with sulfuric acid to yield acidulated material;
Adding ammonium sulfate and MgO to the acidulated material to yield raw material;
Granulating, drying, and sieving the raw material to yield the phosphate ash fertilizer in granule form.

In some embodiments, the incorporation of magnesium provides enhanced nutrient uptake, improved root development, and increased enzyme activation in plants.

In some embodiments, the addition of ammonium sulfate enhances the availability of nitrogen in ammonium form while reducing phosphorus fixation in soil, thereby optimizing plant growth.

### BRIEF DESCRIPTION OF THE FIGURES

FIG. 1 is a depiction of an exemplary diagram of a step one of the process for the production of the fertilizer of the present invention in accordance with some demonstrative embodiments.

FIG. 2 is a graph showing the particle size distribution of the final product as per one of the examples, according to some demonstrative embodiments.

FIG. 3 is a graph depicting the particle size distribution, according to some demonstrative embodiments.

### DETAILED DESCRIPTION OF THE INVENTION

According to some demonstrative embodiments, there is provided herein a mineral phosphate ash fertilizer having a water solubility of 15-55% of total amount of P₂O₅ and a NAC solubility of at least 90% of total amount of P₂O₅, preferably at least 95%, most preferably, at least 99%.

According to some embodiments, the fertilizer may have a pH of 3-3.6.

According to some embodiments, the fertilizer may have an abrasion of 0.05% or less, preferably 0.02% or less, most preferably 0.01%.

According to some embodiments, the fertilizer of the present invention may have a soil solubility of 99% of total P₂O₅ present.

According to some embodiments, the mineral phosphate ash may include, but not limited to any suitable source, e.g., a P source, including sewage sludge ash (SSA), bone meal ash, precipitated Calcium Phosphate (PCP) and the like.

According to some demonstrative embodiments, the P source may include a specific combination of sewage sludge ash (SSA), bone meal ash and precipitated Calcium Phosphate (PCP), e.g., at predetermined ratios.

According to some embodiments, the mineral phosphate ash fertilizer of the present invention may include Triple Super Phosphate (TSP fertilizer) and/or Single Super Phosphate (SSP fertilizer), for example when the P-source is reacted with sulfuric acid, the mineral phosphate ash fertilizer may include SSP, and when the P-source is reacted with phosphoric acid, the mineral phosphate ash fertilizer may include TSP.

Conventional phosphate fertilizers (e.g., TSP and SSP) typically derived from phosphate rock suffer from limited sustainability, increased environmental impact, and restricted availability of phosphate rock resources globally. Moreover, traditional phosphorus sources often exhibit low bioavailability, leading to inefficient uptake by plants and requiring repeated fertilizer applications. The present invention addresses this challenge by utilizing sewage sludge ash (SSA), a previously underutilized or waste product, to provide an alternative, sustainable phosphorus source with enhanced nutrient bioavailability and controlled solubility characteristics.

The inventive fertilizer distinctly exhibits dual solubility profiles: water solubility ranging from 15% to 80% and NAC solubility exceeding 90%, which provides immediate and prolonged phosphorus release. Achieving such optimized phosphorus availability from sewage sludge ash, especially when combined synergistically with ammonium sulfate and magnesium oxide, is not obvious to a person skilled in the art due to the complex interactions and chemical balances involved. Furthermore, incorporating magnesium oxide in a precise ratio with ammonium sulfate significantly improves nutrient uptake, enhances root growth, and mitigates phosphorus fixation in soils, solving an inherent limitation of conventional fertilizers.

According to some embodiments, the fertilizer of the present invention may be formulated in various forms, including, liquid, solid, prills, crystals powder, granules and the like.

According to some embodiments, the fertilizer may preferably be in the form of a granule.

According to some embodiments, the fertilizer of the present invention may possess numerous advantages in comparison to ordinary P fertilizers, e.g., Phosphate rock-based fertilizers. For example, the SSA fertilizer of the present invention may allow for the control over the release of the P from the fertilizer.

According to some demonstrative embodiments, there is provided herein a fertilizer derived from mineral phosphate ash characterized by a water solubility spanning from 15-80% of its overall P₂O₅ content (preferably 15-55%).

According to some embodiments, the fertilizer also demonstrates a NAC solubility of no less than 90% of its P₂O₅ content, with a heightened preference of at least 95% and, ideally, reaching up to 99%.

Based on specific examples, this described fertilizer may possess a pH value situated between 3 and 3.6.

According to some embodiments, the fertilizer's resistance to wear or “abrasion” is capped at 0.05%.

According to some embodiments, the fertilizer possesses a soil solubility that captures 99% of the entire P₂O₅ present.

According to some embodiments, the origin of the mineral phosphate ash is diverse, encompassing multiple apt sources. Examples of these P sources span from sewage sludge ash (SSA), bone meal ash, to precipitated Calcium Phosphate (PCP), and beyond.

According to some embodiments, the primary P source might be an intentional blend of sewage sludge ash (SSA), bone meal ash, and precipitated Calcium Phosphate (PCP), possibly in set combinations.

According to some embodiments, the mineral phosphate ash fertilizer of the present invention may include components like Triple Super Phosphate (TSP fertilizer) and Single Super Phosphate (SSP fertilizer). To elaborate, when the primary P-source interacts with sulfuric acid, SSP might be a component of the resultant fertilizer. On the other hand, phosphoric acid reactions might lead to the inclusion of TSP.

According to some embodiments, the water-soluble phosphate may be the phosphate that may be directly available for absorption into the soil. According to some embodiments, in most fertilizers, the water-soluble phosphate may immediately go in the water phase and hopefully be taken up by the plant.

However, according to some embodiments, the phosphate in the fertilizer of the present invention may not be water soluble, but NAC (‘Neutral Ammonium Citrate) soluble and thus will slowly dissolve due to the activity of the microbiology around the roots of the plant. The phosphate will thus be slowly released and taken up by the plant.

According to some embodiments, the fertilizer of the present invention may further include another fertilizing compound, selected from the group including Anhydrite, Potash, Polyhalite, Ammonium Sulphate, urea, Gypsum, Kieserite, Epsomite, Glauberite, Blodite, Magnesia, Langbeinite, Kainite, Schonite or any other suitable fertilizer.

According to some embodiments, the fertilizing compound may preferably be red Potash.

According to some embodiments, the fertilizer of the present invention may include Polyhalite.

Polyhalite is an evaporite mineral, a hydrated sulfate of potassium, calcium and magnesium with formula: K2Ca2Mg(SO4)4·2H2O. Polyhalite is used as a fertilizer since it contains four important nutrients and is low in chloride:
48% SO₃ as sulfate
14% K₂O
6% MgO
17% CaO

According to some embodiments, the specific combination of Polyhalite and the P₂O₅ of the fertilizer of the present invention allows for a synergistic effect between the controlled release of phosphate and the multi-nutrient release from Polyhalite, for optimal plant growth.

The combination of P₂O₅ nutrients and nutrients from polyhalite allows for an optimal coverage of plant nutrients for best plant nutrition.

In addition, according to some embodiments, the fertilizer of the present invention may demonstrate a greater ability to absorb water (hygroscopic effect), however, surprisingly, the strength of the fertilizer granule is hardly affected by this water absorption, as can be seen, for example, in table 4 and 5 below.

In additional embodiments, the fertilizer may be formulated to include a biodegradable polymer coating to further enhance controlled nutrient release, prolonging the nutrient availability period and further reducing environmental runoff.

According to further embodiments, the SSA-based fertilizer composition may additionally include beneficial microbial inoculants, such as phosphorus-solubilizing bacteria or mycorrhizal fungi, which synergistically enhance phosphorus availability and uptake efficiency by plants.

According to alternative embodiments, the fertilizer granules may include micronutrients encapsulated within the granules' core, improving the delivery and controlled release of essential micronutrients (e.g., zinc, iron, molybdenum) alongside the primary nutrients.

According to some demonstrative embodiments, there is provided herein a process for the production of a mineral phosphate ash fertilizer comprising: a first step of acidulation, comprising mixing a mineral phosphate ash with sulfuric acid, phosphoric acid or a combination thereof, to provide an intermediate product;
a second step of curing (also referred to herein as “soaking”) comprising maintaining the intermediate product in a reactor or a belt between 2 min to 2 hours, preferably for 20 minutes to provide a cured intermediate product; and
a third step of finalizing the fertilizer comprising mixing the cured intermediate product with water or steam and/or one or more fertilizing compounds in a granulator.

According to some embodiments, the first step may be performed in a suitable mixer, preferably a pugmill mixer.

According to some embodiments, when both phosphoric acid and sulfuric acid are added in step one, the ratio of phosphoric acid to sulfuric acid may be between 1:3 to 3:13, and preferably 0.68 phosphoric acid and 0.06 sulfuric acid.

According to some embodiments, in step three, the fertilizing compound may include Anhydrite, Potash, Polyhalite, Ammonium Sulphate, urea, Gypsum, Kieserite, Epsomite. Glauberite, Blodite, Magnesia, Langbeinite, Kainite, Schonite or any other suitable fertilizer.

According to some embodiments, the fertilizing compound may preferably be red Potash.

According to some embodiments, the granulator may include a granulation drum, pan granulator, fluidized bed, an Eirich granulator and the like.

According to some embodiments, the use of a mineral phosphate ash possesses numerous benefits over other processes using phosphate rock. For example, unlike phosphate rock which need to be milled before initiation of the acidulation process, the mineral phosphate ash has a small particle size.

According to some embodiments, the process of the present invention may include the use of gas for creating a bubbling, for example, that may enhance the mixing of the solid-liquid mixture created in the first step, and this allows for the effective mixing and creation of the cured intermediate product.

According to some embodiments, in step three, the cured intermediate product may be mixed together with a fertilizer, e.g., potash, polyhalite, ammonium sulphate optionally in the presence of water and/or steam in a granulator, e.g., granulation drum, pan granulator or Eirich granulator.

According to some embodiments, after a granulation time of 2-10 minutes, preferably 4 minutes, the resulting product may be dried for 10-30 minutes, preferably, 20 min in a drier, e.g., drying drum, belt drier, microwave drier or fluidized bed drier.

According to some embodiments, after drying, the product may be sieved, wherein the final product may have a size of 1-6 mm, preferably between 2 and 5 mm.

According to some embodiments, the product may further be cooled in a cooling drum.

During the granulation phase in the third step of the process of the present invention, water and/or steam may be added to wet the mixture and help the particles bind to one another. The liquid-to-solid ratio is used to determine the amount of water and steam necessary for granulation.

According to some embodiments, for an optimal granulation process, an ideal liquid-to-solid ratio is preferable. This ratio may be unique for every granulation, the steam is added to heat up the granulation bed and the temperature of the bed can vary between 65 and 95 C, preferably 75 C. The residence time in the granulation drum is 1 to 10 minutes, preferably 4 minutes. According to some embodiments, after this step, the granules may be transferred to a dryer, e.g., a rotary drying drum. According to some embodiments, hot air, e.g., at around 450° C., may be blown into the drying drum to dry the granules for 20 minutes.

According to some embodiments, the dried granules may be transported to a sieve tower to be sieved. According to these embodiments, any granules having a size of over 6 mm, preferably over 5 mm, may be crushed in a grinding machine and used as recycle together with smaller granules, for example, granules smaller than 2 mm. Granules in the desired size range, for example 1-6 mm, preferably 2-5 mm may be transported to a cooling drum. According to some embodiments, the granules are cooled down to below 40° C. before storage.

In some embodiments, the mineral phosphate ash fertilizer of the present invention provides an improved formulation that enhances phosphorus bioavailability while incorporating essential secondary nutrients such as magnesium.

### Production Process

In some embodiments, the process for producing the mineral phosphate ash fertilizer comprises:

### Acidulation Step

In some embodiments, a mineral phosphate ash, such as sewage sludge ash (SSA), is mixed with sulfuric acid to form an intermediate phosphate product.

In some embodiments, the reaction mixture is maintained in a reactor for 2 to 20 minutes to allow for optimal acidulation.

### Granulation Step

In some embodiments, the intermediate product is mixed with ammonium sulfate and MgO to form a granulated fertilizer product.

In some embodiments, the granulation step is performed using water and steam in a drum granulator, wherein the granulation time is between 4-5 minutes.

### Drying & Sieving Step

In some embodiments, the granulated product is dried at a temperature of 100-150° C. for a duration of 20 minutes.

In some embodiments, the dried product is sieved, producing a final particle size of 2.5 mm-5 mm.

In some embodiments, recycled material (<2 mm) is incorporated back into the granulation process.

According to some embodiments, the granulation step may utilize recycled fines (<2 mm) from previous production runs, at a ratio of up to 50 wt % of the batch. This enables efficient use of material while maintaining granule quality and strength.

In some embodiments, the formulation may include additives such as binders or anti-caking agents, added in small quantities (e.g., 0.01% to 0.05%) to improve granulation efficiency, flowability, or dust control.

According to some embodiments, granulation may be performed using a drum or pan granulator, with:
water input between 3.5-7 m³/h,
steam input between 1.5-3 t/h,
granulation temperature between 65° C. and 95° C.

Use of red potash may lower the required water input compared to white potash, reducing energy costs and improving granule stability.

According to some embodiments, the present invention allows for the advantageous use of sewage sludge ash as a sustainable phosphorus source to formulate a fertilizer uniquely characterized by controlled phosphorus release and optimal bioavailability. Unlike conventional phosphate rock fertilizers, the invention harnesses a resource traditionally considered waste, providing both environmental and agricultural benefits by converting sewage sludge ash into a valuable fertilizer with superior plant uptake efficiency.

Moreover, the strategic integration of magnesium oxide and ammonium sulfate in carefully controlled ratios substantially improves fertilizer performance, including nutrient availability, root development, and plant growth. According to some embodiments, such integration may create a unique synergy within the fertilizer granule that is neither apparent nor easily achievable from traditional fertilizer formulations.

### Final Product Characteristics

In some embodiments, the fertilizer comprises phosphorus (P₂O₅), nitrogen (N), magnesium (Mg), and sulfate (SO₄).

In some embodiments, the magnesium content ranges between 1-10%.

In some embodiments, the ratio between MgO and ammonium sulfate is controlled between 1:2 and 1:4, preferably 1:2.9, ensuring an optimal nutrient balance for plant uptake.

According to some embodiments, the fertilizer of the present invention comprises magnesium in a concentration between 3% and 10% by weight, preferably around 5%. The magnesium may be provided in the form of magnesium oxide (MgO), and may be blended with the phosphate-rich intermediate and a nitrogen source such as ammonium sulfate.

According to some embodiments, the magnesium source and ammonium sulfate may be added in a fixed weight ratio of approximately 1:2.9, corresponding to about 15% MgO to 44% ammonium sulfate in the formulation. This ratio has been found to provide optimal nutrient availability, granulation behavior, and storage stability.

According to some embodiments, the resulting fertilizer may have a formulation such as NP—Mg 6-27-5, comprising:
6% N (ammoniacal),
27% P₂O₅,
5% Mg,
with low free acidity, high stability under humid conditions, and granules between 2-5 mm in diameter.

In some embodiments, the fertilizer may further comprise potassium in the form of red potash or polyhalite, creating an NPK-Mg product such as NPK 5-5-22 or NPK 6-27-5 with added magnesium.

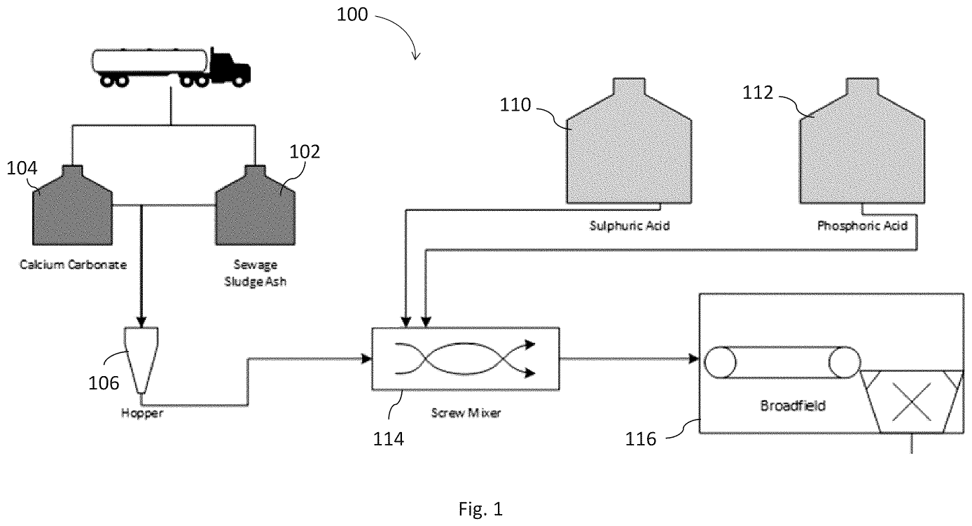

Reference is now made to FIG. 1 which depicts an exemplary diagram of a step one (100) of the process for the production of the fertilizer of the present invention in accordance with some demonstrative embodiments.

As shown in FIG. 1, step 100 may include the mixing of SSA 102 and Calcium Carbonate 104 in a hopper 106 to provide an SSA and Calcium carbonate mixture.

The mixture may then be transferred to a mixer 114, e.g., a screw mixer, into which sulphuric acid 110 and phosphoric acid 112 may be added and mixed to provide an intermediate product.

According to some embodiments, the intermediate product may be transferred to a broadfield 116 for the second step of the process to take place.

According to some embodiments, there is optionally another step called “the granulation step” (not shown in FIG. 1), according to which dry material may be transferred from broadfield 116 to a granulator.

According to some embodiments, MgO and/or other minerals are preferably added during the granulation step.

According to some demonstrative embodiments, the final product of the process described hereinabove is a P-Fertilizer.

According to some demonstrative embodiments, there is provided herein a mineral phosphate ash fertilizer having water soluble P2O5 of 15 to 80%, preferably 15-55% of the total P2O5 present in the fertilizer.

An exemplary analysis of raw materials of two separate batches is presented in table 1.

TABLE 1

| | P₂O₅ | Al₂O₃ | Fe₂O₃ | CaO | SO₃ |
|---|---|---|---|---|---|
| Sample | Tot % | % | % | % | % |
| SSA | 21 | 6.6 | 15.2 | 22.8 | 3.2 |
| Batch 1 | | | | | |
| SSA | 25 | 4.3 | 12.9 | 13.7 | 0.8 |
| Batch 2 | | | | | |

Table 2 shows a chemical analysis of the fertilizer of the present invention from two exemplary batches.

According to some embodiments, the fertilizer may contain a high moisture content of at least 5% w/w, preferably at least 6% w/w, most preferably 6.8% w/w. According to some embodiments, the high moisture content is the result of the unique process described herein above which results from the high moisture content after production and the natural moisture uptake of the product.

According to some embodiments, the fertilizer of the present invention may have a relatively low water-soluble amount of P2O5 of 15-80% or less, but a high NAC % P2O5 of at least 90% w/w, preferably at least 95% w/w, most preferably at least 99% w/w, for example, especially when the P source is bone meal and/or PCP.

According to some embodiments, the fertilizer of the present invention may have a relatively low water-soluble amount of P2O5 of 15-80% or less (preferably, 15-55%), but a high NAC % P2O5 of at least 90% w/w, preferably at least 95% w/w, most preferably at least 99% w/w, for example, especially when the P source is SSA

According to some embodiments, the relatively low water-soluble amount of P2O5 yet the high NAC % P2O5 shows that the phosphate in the product is bio-available for the plant.

TABLE 2

| | P2O5 | P2O5 | P2O5 | K2O | MgO | CaO | SO4 | | Cl | | H2O |
|---|---|---|---|---|---|---|---|---|---|---|---|
| Sample | Ws % | NAC % | Tot % | % | % | % | % | F.A | % | pH | % |
| Batch 1 | 20.9 | 35.0 | 39.0* | 1.2 | 1.8 | 11.2 | 7.7 | 2.4 | 0.6 | 3.3 | 6.8 |
| Batch 2 | 21.8 | 36.8 | 38.3* | 1.3 | 1.9 | 11.1 | 7.3 | 2.6 | 0.8 | 3.3 | 7 |

In Table 3 the analysis of the heavy metals of the fertilizer of the present invention in comparison to the EU limits as defined by the FPR '22.

TABLE 3

| | Al2O3 | Fe2O3 | MgO | As | Cd | Cr | Cu | Hg | Mn | Ni | Pb | Zn |
|---|---|---|---|---|---|---|---|---|---|---|---|---|
| | [%] | [%] | [%] | [ppm | [ppm | [ppm | [ppm | [ppm | [ppm | [ppm | [ppm | [ppm |
| EU-limit | N.A. | N.A. | N.A. | 40 | N.A. | N.A. | 600 | 1 | N.A. | 100 | 120 | 1 500 |
| SSA | 4.3 | 12.9 | N.A. | 51 | 3 | 110 | 1200 | <0.1 | N.A. | 85 | 280 | 2 800 |
| (supplier | | | | | | | | | | | | |
| 1- HVC) | | | | | | | | | | | | |
| SSA SNB | 6.6 | 15.2 | N.A. | 22 | 2 | 115 | 955 | 0.1 | 780 | 69 | 200 | 2 300 |
| SSA | 5.24 | 10.4 | 2.7 | 17.3 | 2 | 69 | 894 | <1 | 782 | 63 | 247 | 2 432 |
| supplier | | | | | | | | | | | | |
| 2 -SNB ) | | | | | | | | | | | | |
| Final | 2.0 | 2.5 | 1.9 | 12 | 11 | 99 | 400 | 0 | 466 | 49 | 92 | 1 338 |
| product- | | | | | | | | | | | | |
| sample | | | | | | | | | | | | |
| 1 | | | | | | | | | | | | |
| Final | 2.1 | 3.5 | 1.8 | 13 | 11 | 98 | 384 | 0 | 449 | 49 | 88 | 1 304 |
| product- | | | | | | | | | | | | |
| sample 2 | | | | | | | | | | | | |

According to some embodiments, the fertilizer of the present invention has an abrasion of 0.05% or less, preferably 0.03% or less, most preferably 0.01%.

According to these embodiments, the low abrasion level of the fertilizer of the present invention may produce very little dust during transport and handling.

Table 4 presents the results of a strength test before and after a climate chamber test, thereby representing the granule strength.

As can be seen from table 4, the average strength of the granules is around 30 N, and according to some embodiments, the granules may stay strong during storage in the warehouse. As shown in the results, the strength of the granule of the fertilizer of the present invention is not reduced significantly after 24 hrs in the climate chamber (24 hrs, 21° C. and 70% humidity) and picking up 6 wt % humidity.

TABLE 4

| Sample | AVG [N] | STD Div | Remarks |
|---|---|---|---|
| Before | 31 | 4 | Strong light |
| Climate | | | gray granules |
| Chamber | | | |
| After Climate | 28 | 5 | Darker color, |
| Chamber | | | feels strong |

Table 5 shows the moisture uptake of the granule of the present invention after 24 hrs in the climate chamber. According to some embodiments, it is evident that the quality of the granules after the climate chamber stays stable. According to some embodiments, the storage of the granule in a warehouse in high humidity conditions will not damage the granule.

TABLE 5

| | Humidity | |
|---|---|---|
| | Uptake | |
| Sample | [wt %] | Remarks |
| Batch 1 | 5.67 | Darker shade of color, |
| | | still strong, very small |
| | | stick to bottom and bit |
| | | sweating but not moist |
| | | feeling |

### Example 1

Experiment starts by weighting dry components with a p-source. In a beaker the surfactant is mixed with desired acid (sulfuric acid and/or phosphoric acid). The liquids in the beaker are mixed and the dry materials are added to the liquid. The mixing takes five seconds and is stopped. Afterwards the material continues to react for 20 min. Directly after mixing the temperature is measured. After 20 min, the material is crushed to powder and analyzed. During the whole process the quality aspects are noted; cake rise, temperature increase, stickiness, powder quality, dryness and crushability.

TABLE 6

| | SSA | H2SO4 | Phosphoric acid | Resulting | Reaction Time | | Cake |
|---|---|---|---|---|---|---|---|
| Experiment | [g] | (75%) [g] | (53%) [g] | ROP [g] | [min] | T [C] | Forming |
| SSP (SSA) | 180 | 146 | | 332 | 20 | 102 | 4.9 |
| TSP (SSA) | 180 | | 270 | 451.5 | 20 | | N.A. |

TABLE 7
Typical Analysis:

| | P2O5 % | | K2O | MgO | CaO | | | | | | |
|---|---|---|---|---|---|---|---|---|---|---|---|
| | Water | P2O5 % | % | % | % | SO4 | Free | Cl % | | | Acidulation |
| Experiment | soluble | TOT | TOT | Total | TOT | % | Acid | TOT | Ph | Humidity | Yield (%) |
| SSP | 5.3 | 11 | 0.7 | 1.7 | 14.6 | 35.5 | 13.4 | 0.3 | 2.1 | 9.2 | 48.4 |
| (SSA) | | | | | | | | | | | |
| TSP | 29.4 | 37.75 | 6.8 | 1.5 | 2.6 | 1.5 | 5.5 | 0.2 | 2.9 | 12.9 | 77.8 |
| (SSA) | | | | | | | | | | | |

TABLE 8

| | 0 | 5 |
|---|---|---|
| Unstickiness | Very sticky | Not sticky at all |
| Powder | Hard rocks, it's not | Fine Powder |
| | possible to form | |
| | powder | |
| Cake | No cake forming | Very nice cake |
| Forming | | forming |
| Dryness | Very Wet | Perfectly dry |
| Crushability | Hammer is required | No need to crush |
| | to crush | |

The results indicate that SSA can be acidulated using phosphoric acid or sulfuric acid. The resulting ROP has a good quality and can be used for granulation.

### Example 2

Experiment testing the third step of the process of the present invention initiated by mixing dry materials together; the SSA cured intermediate product, potash, Polyhalite, ammonium sulfate (total 2 kg). The dry materials are added to a granulation drum. To mimic the factory, experiments are also done with recycle (material smaller than 2 mm from another run). The granulation is started by turning on the granulation drum and adding water and steam. After 4 min the granulation drum is stopped, and the material is transferred to the drying drum. The material is dried for 20 min. After the drying the material is sieved and analyzed for chemical composition, strength, abrasion, hygroscopicity and particle size distribution.

TABLE 9

| | | | | | | Steam | Gran | T | Drying | |
|---|---|---|---|---|---|---|---|---|---|---|
| | SSA | Potash | Recycle | H2O | Steam | Time | time | Gran | Time | GRAN |
| Sample | ROP [g] | [g] | [g] | [g] | [g] | [sec] | [min] | Bed [C] | [min] | [g] |
| Typical | 1712 | 0 | 288 | 170 | 121.3 | 70 | 6:00 | N.A. | 20 | 1750 |

TABLE 10

| P2O5 | | | | | | | | | |
|---|---|---|---|---|---|---|---|---|---|
| % | P2O5 | K2O | MgO | CaO | | | Cl | | |
| Water | % | % | % | % | SO4 | Free | % | | Humi- |
| soluble | TOT | TOT | TOT | TOT | % | Acid | TOT | Ph | dity |
| 16 | 34.6 | 3.6 | 2.0 | 8.6 | 7.1 | 1.6 | 1.9 | 3.4 | 4.8 |

Table 10

### Example 3

Experiment testing the third step of the process of the present invention initiated by mixing dry materials together; the SSA cured intermediate product, potash, Polyhalite, ammonium sulfate (total 2 kg). The dry materials are added to a granulation drum. To mimic the factory, experiments are also done with recycle (material smaller than 2 mm from another run). The granulation is started by turning on the granulation drum and adding water and steam. After 4 min the granulation drum is stopped, and the material is transferred to the drying drum. The material is dried for 20 min. After the drying the material is sieved and analyzed for chemical composition, strength, abrasion, hygroscopicity and particle size distribution.

TABLE 11

| | SSP | Ammonium | | | | Granulation | | 2 mm < | | |
|---|---|---|---|---|---|---|---|---|---|---|
| | ROP | sulfate | Potash | Water | Steam | Time | >2 mm | x > 5 | <5 mm | % |
| Experiment | (SSA) [g] | [g] | [g] | [g] | [g] | [min] | [g] | mm [g] | [g] | water |
| 1 | 802.9 | 500 | 704.7 | 102.3 | 92.8 | 3:30 | 181 | 650 | 1004.5 | 8.9 |
| 2 | 800 | 504 | 700 | 80.8 | 78.7 | 4:00 | 236.4 | 1360.7 | 139.4 | 7.4 |

The experiment proves it is possible to produce an NPK product made out of ROP based on sewage sludge ash, ammonium sulphate and potash.

TABLE 12

| | | P2O5 | P2O5 | K2O | MGO | CAO | SO4 | FREE | CL | | |
|---|---|---|---|---|---|---|---|---|---|---|---|
| | N-NH4 | WS | TOT | TOT | TOT | TOT | TOT | ACID | WO | | |
| SAMPLE | % | % | % | % | % | % | % | % | % | PH | HUMIDITY |
| EXPERIMENT 1 | 4.7 | 1.1 | 4.7 | 22.7 | 0 | 5.3 | 34.2 | 3.7 | 18.9 | 2.9 | 0.8 |

It can be seen from table 12 that the P2O5 water solubility (WS) is 23% (1.1/4.7).

### Example 4

Experiment testing the third step of the process of the present invention initiated by mixing dry materials together; the Bonemeal and Precipitated Calcium Phopshate cured intermediate product, potash, Polyhalite, ammonium sulfate (total 2 kg). The dry materials are added to a granulation drum. To mimic the factory, experiments are also done with recycle (material smaller than 2 mm from another run). The granulation is started by turning on the granulation drum and adding water and steam. After 4 min the granulation drum is stopped, and the material is transferred to the drying drum. The material is dried for 20 min. After the drying the material is sieved and analyzed for chemical composition, strength, abrasion, hygroscopicity and particle size distribution.

TABLE 13

| | PCP | BMA | | | | |
|---|---|---|---|---|---|---|
| | SSP | SSP | | | Gran | |
| | ROP | ROP | H2O | Steam | time | GRAN |
| Explanation | [g] | [g] | [g] | [g] | [min] | Efficiency |
| Granulation with | | 2037.8 | 48.2 | 106.0 | 5:30 | 59% |
| bone meal | | | | | | |
| Granulation PCP | 2001.1 | | 48.4 | 81.9 | 6:00 | 58% |

TABLE 14

| | P2O5 | P2O5 | K2O | TOT | CaO | | | | | |
|---|---|---|---|---|---|---|---|---|---|---|
| | % | % | % | MgO | % | SO2 | Free | Cl % | | |
| Sample | WS | TOT | TOT | % TOT | TOT | % | Acid | TOT | pH | Humidity |
| Granulation with | 14.5 | 19.2 | 1.5 | 0.8 | 25.9 | 37.8 | 7.9 | 0.4 | 2.3 | 2.4 |
| bone meal | | | | | | | | | | |
| Granulation | 20.7 | 21.7 | 0 | 0.5 | 28.6 | 40.9 | 4.9 | 0.1 | 2.7 | 3.1 |
| PCP | | | | | | | | | | |

The experiment proves it is possible to produce a final product made out of ROP from PCP or bone meal.

### Example 5

Experiment testing the third step of the process of the present invention initiated by mixing dry materials together; the SSA cured intermediate product, potash and Polyhalite (total 2 kg). The dry materials are added to a granulation drum. To mimic the factory, experiments are also done with recycle (material smaller than 2 mm from another run). The granulation is started by turning on the granulation drum and adding water and steam. After 4 min the granulation drum is stopped, and the material is transferred to the drying drum. The material is dried for 20 min. After the drying the material is sieved and analyzed for chemical composition, strength, abrasion, hygroscopicity and particle size distribution.

TABLE 15

| | SSA | | | | | GRAN | |
|---|---|---|---|---|---|---|---|
| | SSP | POTASH | POLYHALITE | H2O | STEAM | TIME | GRANULATION |
| EXPLANATION | ROP [G] | [G] | [G] | [G] | [G] | [MIN] | EFFICIENCY |
| GRANULATION | 1002.3 | 1001.6 | 0 | 79 | 53 | 6:11 | 44% |
| SSP SSA + | | | | | | | |
| POATASH | | | | | | | |
| GRANULATION | 1000 | 0 | 1002.3 | 174 | 53 | 4:00 | 48% |
| SSP SSA + | | | | | | | |
| POLYHALITE | | | | | | | |
| GRANULATION | 1001.7 | 500.3 | 499.8 | 95 | 50 | 4:00 | 25% |
| SSP SSA + | | | | | | | |
| POTASH + | | | | | | | |
| POLYHALITE | | | | | | | |

TABLE 16

| | | | P2O5 | P2O5 | K2O | CAO | | | CL | | |
|---|---|---|---|---|---|---|---|---|---|---|---|
| | N-NH4 | N-NO3 | % | % | % | % | SO2 | FREE | % | | |
| SAMPLE | % | % | WO | TOT | TOT | TOT | % | ACID | TOT | PH | HUMIDITY |
| GRANULATION | 0.3 | 0 | 1 | 6.3 | 30.7 | 7.1 | 19.5 | 3.8 | 21.9 | 2.8 | 2.6 |
| SSP SSA + | | | | | | | | | | | |
| POTASH | | | | | | | | | | | |
| GRANULATION | 1.4 | 0 | 0.8 | 8.1 | 5.8 | 14.2 | 42.7 | 4.3 | 3.7 | 2.7 | 0.6 |
| SSP SSA + | | | | | | | | | | | |
| POLYHALITE | | | | | | | | | | | |

Experiment 5 indicates that it is possible to granulate the SSP ROP made from SSA with potash, polyhalite and a combination of both.

### Example 6

The goal of this experiment is to develop products made from recycled sources of phosphate. One of these alternative sources of phosphate is Sewage Sludge Ash (SSA). Based on experiments done in the pilot plant, SSP ROP made from SSA could be used in a NPK production. The pilot experiments were performed with Ammonium Sulfate and Dead Sea Potash (DSP). During the test described in this example a NPK 5-5-22 product was produced using SSA as the P-source. This example will describe the granulation process and the quality of the final granular product.

### Test Run

For this test run SSA-based Single Superphosphate (SSP) Run of pile (ROP) was used. Furthermore, ammonium sulfate, DSP and later on in the run potash Standard were used as raw materials. On top of that slurry water and steam were used during the granulation.

The test run started at around 11.25 on the 20 of Sep. 2022. The input values were set to 17 t/h SSP ROP, 10 t/h ammonium sulfate and 15 t/h potash. Initially the granulated mixture left the granulation drum as a very fine mixture of granules, which led to a big recycle stream. The granulation was not working as well as in the pilot. Therefore, the decision was made to increase the water flow from 3 m3/h to 4.5 m3/h while maintaining a steam rate of around 2.5 t/h as to approach an optimum ratio of solid and liquid phase in the granulation drum, which is crucial for the granulation process. This led to an improvement in granulation, whilst not increasing the recycle stream.

TABLE 17
overview test

| | SSP | Ammonium | | | | | T | |
|---|---|---|---|---|---|---|---|---|
| | ROP | sulfate | Potash | Water | Steam | Recycle | Gran | % |
| Time | [t/h] | [t/h] | [t/h] | [m3/h] | [t/h] | [t/h] | Bed [C] | Water |
| 12:20 | 17 | 10 | 15 | 6.8 | 2.8 | 70 | 78.7 | 9.45 |
| 13:25 | 18 | 10 | 15 | 6.3 | 2.7 | 75 | 91.8 | 8.67 |
| 14:00 | 18 | 10 | 15 | 11 | 2.8 | 88 | 80.7 | 11.01 |

At approximately 12.20 the temperature in the granulation bed was measured the temperature was around 78.7° C. Notable was the fact that the granules didn't appear to granulate homogenously. The water input was increased further to 8.3 m3/h, while the steam rate was 2.7 t/h to improve the granulation. This had the side effect that the temperature in the drying step also needed to be increased as to properly evaporate all the added water in the granules. This side effect led to an increased gas consumption which exceeded 1000 m3/h.

Because the output still was not rising even though the increased water input, the recycle build up. At around 12.45 the decision was made to stop the addition of raw materials to the system as to avoid overloading the factory. The recycle stream eventually did granulate and decreased. At 13.25 the granulation bed had a temperature of 91.8° C. This could have been caused by the fact that only recycled material was being added to the granulation drum. The heat from the recycled temperature had not dissipated yet causing a higher temperature in the granulation bed.

The decision was made to continue the test for a little bit longer and increase the water addition further. Furthermore, the addition of raw materials was slightly changed and the SSP ROP was increased from 17 t/h to 18t/h. The water input at this point was 6.3 m3/h, while the steam input was 2.7 t/h. Since the recycle rate was getting too high, the decision was made at 14.00 to halt the input of raw materials to lessen the burden on the system.

At 15:30 the test run was resumed and the input ratios of raw materials were set at 19 t/h SSP ROP, 10 t/h ammonium sulfate and 15 t/h potash with a water input of about 5.1 m3/h and a steam input of 2.4 t/h. The water input was steadily increased until it reached a value of approximately 9 m3/h as it was clear that to increase the granulation efficiency, more water was needed. This coincided with the output of product reaching a value of over 40 t/h. It was concluded that the granulation is working at high wetness. The product coming out of the granulation drum seems very wet and no granules can be distinguished. The granulation of the material continues in the first meters of the drying drum where there are no lifters yet. 10 t/h of this potash type was added for the remainder of the test run. The amount of water being added at this point was about 7.5 m3/h).

### Results & Discussion

During the run, it was imperative to reach a final product output value that equaled the total input of raw material. Therefore, the aim was to reach an output of approximately 40 t/h. This goal was eventually reached. The first moment a true output of 40 t/h was reached was at 5.00 pm as the peak at 3.30 occurred when only recycled material was present in the system. The parameters that were changed throughout the test run to reach an increase in output were the water input, the ratio of raw materials, and the type of raw materials used.

The first major obstacle during this test run was determining the optimal water ratio to obtain desired granulation. The high rate of recycled material cycling through the system at the start of the test run was likely also caused by an inappropriate water input, causing the granules to not properly granulate as the ratio between the solid phase and liquid phase was not sufficient for granulation to occur. When the desired output was reached at 5 p.m. the water output was approximately 9 m3/h. But to increase and subsequently sustain an output of minimally 40 t/h the water expenditure of the process was increased up to 11 m3/h which led to an output of 45 t/h, with peaks of 50 t/h. The granulation of SSP ROP has to be performed using high amounts of water. Also notable was the drop in water demand after 8.00 pm. The water demand at that point dropped from 9.5 m3/h to approximately 8 m3/h. This gives the impression that the process has a lower water expenditure when Potash is used.

The problem with water input also led to issues with the gas consumption as water in the granules of the recycle stream had to be dried, more heat was needed in the drying drum in order to reach the required humidity in the granules. At 2.00 pm when the drying drum had reached its capacity limit, the gas consumption exceeded 1100 m3/h.

The ratio of raw material input was slightly altered throughout the run, but this didn't have any significant effect on the output of the product. It can be concluded that for efficient granulation, a high amount of water is needed.

Table 17 shows the chemical analysis of the SSP ROP and final product during the run. The nitrogen was relatively high in the beginning of the run. At the same time the recycle was analyzed and had higher nitrogen content. It is expected that the increased nitrogen level is partly a residue from the previous run and not caused by segregation during granulation of the nutrients or increased dosing of ammonium sulfate. After stabilizing the process around 17:00, the chemical content of the final product is constant with a slight decrease in nitrogen content.

TABLE 18
Overview Chemical Analysis Test Run

| | | | P2O5 | P2O5 | K2O | K2O | MgO | CaO | SO4 | | Cl | | |
|---|---|---|---|---|---|---|---|---|---|---|---|---|---|
| | | N-NH4 | WS | Tot | WS | Tot | Tot | Tot | Tot | Free | WO | | |
| Sample | Time | % | % | % | % | % | % | % | % | Acid | % | pH | Humidity |
| SSP | 13:2 | 0.1 | 3.9 | 12.6 | 1.6 | 1.9 | 1.9 | 13.4 | 34.4 | 7.7 | 2.7 | | 7.4 |
| ROP | 1:22 | | | | | | | | | | | | |
| SSP | 19:0 | 0 | 2.7 | 13 | 1.5 | 2.6 | 2 | 12 | 34 | 6.5 | 2.8 | | 6.9 |
| ROP | 6:03 | | | | | | | | | | | | |
| Final | 13:2 | 7.7 | 2.1 | 6.3 | 19.4 | 19.9 | 0.8 | 5.1 | 35.6 | 1.1 | 15 | 3.4 | 2.7 |
| Product | 4:24 | | | | | | | | | | | | |
| W115 | 13:4 | 8.5 | 2.3 | 5.9 | 19.1 | 19.9 | 0.8 | 4.8 | 37.8 | 1 | 14.6 | 3.4 | 1.4 |
| (recycle) | 2:14 | | | | | | | | | | | | |
| Final | 15:1 | 6.4 | 0.9 | 5.3 | 21.1 | 22.4 | 0.7 | 5.3 | 33.5 | 1.6 | 16 | 3.2 | 2.7 |
| Product | 0:07 | | | | | | | | | | | | |
| Final | 16:5 | 5.1 | 0.8 | 5.5 | 22.4 | 23 | 0.8 | 5.7 | 31.7 | 2.7 | 17.5 | 2.9 | 2 |
| Product | 4:55 | | | | | | | | | | | | |
| Final | 17:3 | 4.9 | 0.8 | 5.5 | 22.5 | 23.6 | 0.8 | 5.8 | 31.4 | 2.8 | 17.6 | 2.9 | 1.9 |
| Product | 6:27 | | | | | | | | | | | | |
| Final | 19:0 | 4.8 | 0.8 | 5.7 | 21.7 | 22.8 | 0.8 | 6.1 | 31.3 | 2.6 | 16.9 | 2.9 | 2.5 |
| Product | 6:07 | | | | | | | | | | | | |
| Final | 21:0 | 4.6 | 0.7 | 5.9 | 23.7 | 25.4 | 5.5 | 31.9 | 2.5 | 18.8 | 2.9 | 2 | |
| Product | 4:10 | | | | | | | | | | | | |
| AVG | N.A. | 5.6 | 1.0 | 5.7 | 21.8 | 22.9 | 0.8 | 5.6 | 32.6 | 2.2 | 17.0 | 3.0 | 2.3 |
| FP | | | | | | | | | | | | | |

### Final Product

We will now discuss the quality of the final product. The quality is assessed by the chemical composition, NAC % analysis, heavy metals analysis and physical quality (abrasion, strength, hygroscopicity and particle size distribution).

TABLE 19
Chemical Analysis Final product

| | | P2O5 | P2O5 | K2O | MgO | CaO | SO4 | Free | Cl | | |
|---|---|---|---|---|---|---|---|---|---|---|---|
| | N-NH4 | WS | Tot | Tot | Tot | Tot | Tot | Acid | WO | | H2O |
| Sample | % | % | % | % | % | % | % | % | % | pH | % |
| Final | 5 | 0.6 | 6.2 | 23.3 | 0.8 | 5.7 | 33.3 | 2.5 | 18.9 | 2.9 | 2.6 |
| Product | | | | | | | | | | | |
| NPK 5- | | | | | | | | | | | |
| 5-22 | | | | | | | | | | | |

The final product was named NPK 5-5-22. Table 19 shows the chemical analysis of the product. As can be seen for the N, P and K fraction the minimum values have been obtained. The product has a higher abrasion that standard P or PK products. The abrasion is lower than the abrasion measured for a standard NPK product. The relatively high abrasion is further supported by the fact that during transport of the product from the factory to the storage facility a lot of fine dust was released.

TABLE 20
Abrasion

| Sample | Abrasion |
|---|---|
| NPK 5-5-22 | 0.40% |
| (SSA) | |
| NPK 11-9-16 | 0.59% |
| NPKS 6-9-24 + | 0.26% |
| 3 MgO + 0.1 B | |
| LC | |
| PKpluS 21-10 + | 0.21% |
| 2 MgO | |
| P 39 | 0.20% |

TABLE 21

| Sample | Humidity | Remarks |
|---|---|---|
| Final Product | Uptake | No significant |
| (NPK 5-5-22) | 3.43% | color change, |
| | | still strong, little |
| | | bit of a stick to |
| | | the container |
| | | but not |
| | | significant. |

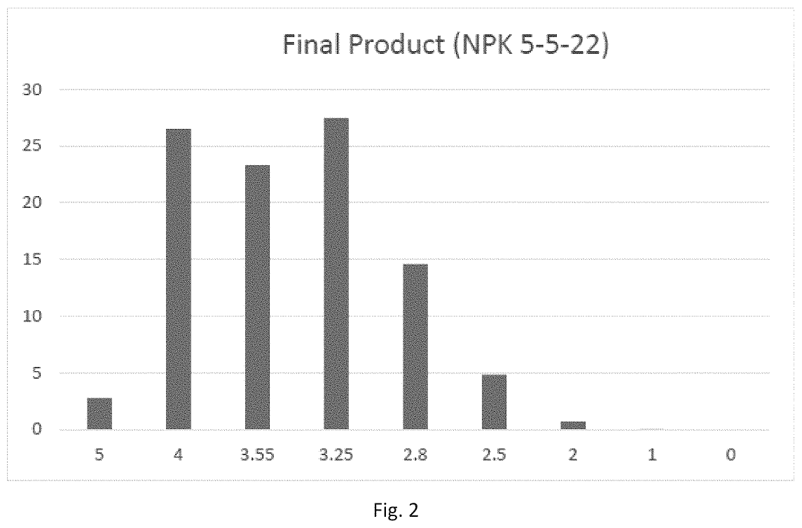

The high occurrence of fine dust is surprising, when data from the particle size distribution (FIG. 2) shows that the particles tend to fall on the bigger side of the on-size spectrum (>2 mm, <5 mm). The humidity uptake of the product seems to be very low, whilst the quality of the granules doesn't seem to be impacted too much by storage in warehouse with relatively high humidity.

### CONCLUSION

The optimum water input for a raw material input of 19 t/h SSP ROP, 9 t/h for Ammonium Sulfate and 14.5 t/h for Fine White Potash lays between 9 and 11 m3 water per hour. However, when Fine White Potash is replaced with Red potash the necessary water input declines to 7.5 m3 and 8 m3 water per hour. This in turn also saves energy cost in the form of less gas expenditure during the drying step. This makes red potash a better option for a K-source in conjunction with SSA as a P-source and Ammonium Sulfate as a N-source for a NPK product. The chemical analysis of the final product is also promising as the parameters agree with the parameters of an NPK 5-5-22.

### Example 7

### Example 1: NPK 6-27-5Mg

In some embodiments, an NP—Mg fertilizer is produced using SSA as the phosphorus source.

Materials:
TSP-SSA cured intermediate product—1115 g
MgO—150 g
Ammonium sulfate—440 g
Steam and water—150 g
Total mixture weight: 1.7 kg

Process Conditions:
Granulation time: 5 minutes
Drying time: 20 minutes
50% wt. recycled material used

TABLE 22

| | TSP | | | | Steam | | | | | |
|---|---|---|---|---|---|---|---|---|---|---|
| | ROP | | Ammonium | | + | Granulation | | 2 mm < | | |
| Run | (SSA) | Recycle | sulfate | MgO | Water | Time | >2 mm | x > 4 | <4 mm | % |
| # | [g] | (<2 mm) | [g] | [g] | [g] | [min] | [g] | mm [g] | [g] | water |
| 1 | 1115 | — | 440 | 150 | 150 | 5 | 20 | 675 | 757 | 6 |
| 2 | 613 | 768 | 220 | 75 | 170 | 5 | 100 | 1007 | 481 | 6 |

The material produced from mix of recycled material and fresh feed is analyzed for particles size distribution and chemical analysis. The experiment proves it is possible to produce an NP—Mg product made from ROP based on sewage sludge ash, ammonium sulphate and Magnesia.

TABLE 23

| Magnesium, | N- | P₂O₅ Water | Phosphorus, |
|---|---|---|---|
| as Mg | NH4 | Soluble | as P₂O₅ |
| 5.19 | 6.02 | 13.7 | 26.7 |

### Example 8

### NP 10-28+Additive

Experiment testing the third step of the process of the present invention initiated by mixing dry materials together; 769.6 gr TSP-SSA cured intermediate product, 43.5 gr MgO and 243.5 gr ammonium sulfate and 0.317 g additive (total 1.07 kg). The dry materials are added to a granulation drum. The granulation started by turning on the granulation drum and adding water and steam. After 4 min the granulation drum is stopped, and the material is transferred to the drying drum. The material is dried for 20 min. After drying the material is sieved. To mimic the factory, experiments are also done with ~50% wt. recycle (material smaller than 2 mm from another run).

TABLE 24

| | SSA | | Ammonium- | |
|---|---|---|---|---|
| | ROP | Magnesium | sulfate | Additive |
| Product | [g] | [g] | [g] | [g] |
| NP 5-28 + | 769.6 | 43.5 | 243.5 | 0.317 |
| MgO + | | | | (0.03 |
| add. | | | | wt %) |

TABLE 25

| Process | NP 5-28 + |
|---|---|
| conditions | MgO + add |
| Steam (g) | 41.33 |
| Water (g) | 149.7 |
| Granulation | 4:20 |
| time | |

The material produced from mix of recycled material and fresh feed is analyzed for particles size distribution and chemical analysis. The experiment proves it is possible to produce an NP—Mg product made from ROP based on sewage sludge ash, ammonium sulphate and Magnesia using an additive.

TABLE 26

| Magnesium, | N- | P₂O₅ Water | Phosphorus, |
|---|---|---|---|
| as Mg | NH4 | Soluble | as P₂O₅ |
| 4.00 | 5.00 | 11.8 | 25.3 |

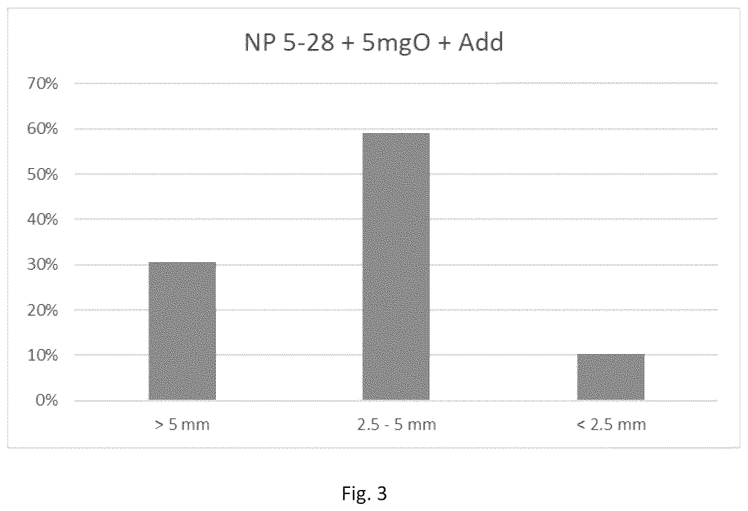

Reference is made to FIG. 3 which depicts a graph showing the particle size distribution with the percentage on the y-axis and the size in mm on the x-axis. The size between 2.5 and 5 mm is the wanted particle size and the percentage of particles in this size represents the granulation efficiency. The granulation efficiency is above 60% showing good results.

While this invention has been described in terms of some specific examples, many modifications and variations are possible. It is therefore understood that within the scope of the appended claims, the invention may be realized otherwise than as specifically described.

What is claimed is:

1. A mineral phosphate ash fertilizer produced from sewage sludge ash, comprising:
a NAC solubility of at least 90% of the total amount of P₂O₅;
a water solubility of 15-80% of the total amount of P₂O₅;
Magnesium in a concentration of 1-10%;
Ammonium sulfate; and
wherein the ratio between MgO and ammonium sulfate is between 1:2 to 1:4.

2. The fertilizer of claim 1, wherein said water solubility of the total amount of P₂O₅ is 15-55%.

3. The fertilizer of claim 1, wherein said NAC solubility of the total amount of P₂O₅ is at least 95%.

4. The fertilizer of claim 3, comprising an abrasion of 0.05% or less.

5. The fertilizer of claim 4, comprising an abrasion of 0.02% or less.

6. The fertilizer of claim 5, further comprising CaSO₄.

7. The fertilizer of claim 8, further comprising Iron Phosphate or Aluminum Phosphate in a concentration of at least 5% w/w.

8. The fertilizer of claim 9, further comprising Ca(H₂PO₄)2H₂O.

9. The fertilizer of claim 1, having a water uptake of at least 5% and a strength of at least 25 Newtons, after being placed in a climate chamber.

10. A process for the production of a mineral phosphate ash fertilizer comprising P2O₅, said process comprising:
mixing a mineral phosphate ash with a gas and sulfuric acid, phosphoric acid or a combination thereof, to provide an intermediate product;
maintaining the intermediate product in a reactor or a belt between 2 minutes to 2 hours, to provide a cured intermediate product;
mixing said cured intermediate product with water or steam in a granulator; and
Adding ammonium sulfate and MgO to the granulated material.

11. The process of claim 12, wherein said mixing a mineral phosphate ash with sulfuric acid, phosphoric acid or a combination thereof is performed using bubbling.

12. The process of claim 13, wherein said mixing said cured intermediate product with water or steam in a granulator further comprises adding a fertilizing compound.

13. The process of claim 14, wherein said fertilizing compound is selected from the group including Anhydrite, Potash, Polyhalite, Ammonium Sulphate, Urea, Gypsum, Kieserite, Epsomite. Glauberite, Blodite, Magnesia, Langbeinite, Kainite, Schonite or any other suitable fertilizer.

14. A process for the production of a mineral phosphate ash fertilizer comprising:
(a) mixing a mineral phosphate ash with sulfuric acid, phosphoric acid, or a combination thereof, optionally using a gas to assist mixing, to produce an intermediate product;
(b) curing the intermediate product in a reactor or belt for a duration of 2 minutes to 2 hours to form a cured intermediate;
(c) granulating the cured intermediate by mixing with water and/or steam;
(d) adding magnesium oxide and ammonium sulfate during or after granulation; and
wherein the weight ratio of MgO to ammonium sulfate is between 1:2 and 1:4.
